(19) United States
(12) Patent Application Publication
(10) Pub. No.: US 2005/0006438 A1
(43) Pub. Date: Jan. 13, 2005

(54) Method for friction stir welding

(76) Inventors: Claes-Goran Andersson, Nykvarn (SE); R.E. Andrews, Essex (GB)

Correspondence Address: ALBIHNS STOCKHOLM AB, BOX 5581, Linnegatan 2, SE-114 85 STOCKHOLM; Sweden, STOCKHOLM, SE

(21) Appl. No.: 10/492,643

(22) PCT Filed: Oct. 23, 2002
(86) PCT No.: PCT/SE02/01932

(30) Foreign Application Priority Data
Oct. 23, 2001 (SE) 01035336

(51) Int. Cl. B23K 20/12

(52) U.S. Cl. 228/112.1

(57) ABSTRACT

The invention relates to a method of friction stir welding in which use is made of a rotating friction stir welding tool, said tool having a probe, the method comprises, (a) temperature control of the tool during welding of a workpiece of hard to weld materials by passing a temperature controlling coolant through one or more channels in the tool in order to control the temperature of the probe, thereby removing excessive heat from the tool and from the area of the workpiece being welded, (b) said coolant having a predetermined first temperature upon entering the tool, (c) measuring a second predetermined temperature indicative of the tool probe temperature, and (d) controlling the welding process such that the tool probe is kept essentially at a predetermined tool probe temperature. The invention also relates to a combination for performing the method.

### FIELD OF THE INVENTION

The present invention relates to a method of friction stir welding using temperature control, and a friction stir welding probe with a temperature controlling arrangement.

### REFERENCE TO RELATED APPLICATION

Reference is hereby made to commonly assigned, co-pending application 0101663-3, filed in which an improved friction stir welding probe is described, and which is incorporated here by reference.

### BACKGROUND OF THE INVENTION

Friction stir welding represents a relatively new welding technique. The technique has been developed welding metals and alloys which have been difficult to weld on account of e.g. thickness of the metal/alloy to be joined or simply metal/alloys that have been difficult to weld due to the need of special shielding gases and specially in thick material the need to eliminate voids and/or solidification cracking defects as the weld cools down.

Generally one may say that within the welding technique the thickness of the metal/alloy to be joined presents probably the greatest obstacle to achieving a good weld.

In friction stir welding a rotating shouldered cylindrical tool is used to create mechanical friction in the metal in contact with the rapidly rotating cylindrical tool. The mechanical friction plasticizes the metal in contact with the rotating tool due to the heat evolved by the friction between the tool and the metal to be joined. Such a probe may be found in EP-A2-0,810,056.

In FIG. 1A and FIG. 1B a prior art friction stir welding probe is shown. As shown two parts 10A′ and 10B′ are aligned so that the edges of the parts to be welded together are held in direct contact. A friction stir welding tool has a shoulder 14′ at its distal end and a non-consumable welding probe 16′ extending downwards centrally from the shoulder. As the rotating tool W′ is brought into contact with the interface between plates 10A′ and 10B′ a rotating probe 16′ is forced into contact with the material of both plates as shown.

The probe is made from a material harder than the work piece material and is caused to enter the joint region and opposed portions of the workpieces on either side of the joint region while causing a relative cyclic movement, e.g. a rotational or reciprocal movement between the probe and the workpieces whereby frictional heat is generated to cause the opposed portions of the workpieces to be plasticized. The probe in creating a weld will be moved in the direction of the joint region. As the probe moves, the plasticized metal/alloy will consolidate and thus join the workpieces together.

Other examples of friction stir welding are described in EP-B-0615480 and WO 95/26254. Other examples of tools are described in e.g. GB-A-2306366, WO 99/52669, and WO99/58288.

Further, the problem of evolved heat has been disclosed in EP-A2-0,810,056 (mentioned above), in connection with the welding of aluminum where the problem encountered was that the weld produced needed machining on account of the resulting weld being rough. It was recognized that cooling of the tool, when welding materials that are difficult to weld, such as aluminum alloys (essentially non-extrudable) during the welding process, reduces the tendency of the softened metal to adhere to the rotating probe and shoulder of the tool, thus giving a smother surface. The tool disclosed has internal spaces or an external jacket, through which the coolant can be pumped to remove heat and cool the tool during welding operations. A further described embodiment comprises a device for spraying a coolant onto exterior surfaces of the distal end of the welding tool to thereby remove heat from the tool, and the surrounding workpiece, during welding.

The tools used for friction stir welding generally comprises a cylindrical or tapered probe projecting from a larger diameter flat or domed shoulder. The depth to width ratio of the probe length versus its normal diameter is of the order of 1:1 and the ratio of the shoulder diameter to the probe length is of the order of 3:1 or 4:1, as first disclosed in EP-B-0615480 for welding 3 mm thick and 6 mm thick sheets and plates in an aluminum alloy.

For welding thicker plates of 15 mm up to 25 mm in a single pass, the thickness varying between 15 to 25 mm probes of the type having a 1:1 length/diameter could be used, however these probes tend to displace an excessive amount of material. As the plates grow thicker scaled-up probes of known type will displace increasing amounts of material and trials have shown that this is not a recommended way of solving the problem. However, the welding of thicker materials will necessitate a higher input of pressure put on the probe indicating that it may be a problem to lengthen the probe without making it wider.

One crucial point in the process of joining work pieces using friction stir welding when it comes to work pieces of greater dimensions is the “plunge sequence”, i.e. the start of the welding process when the probe is lowered into the joint line. The problem seems to be that during the plunge sequence most of the heat generated is rapidly conducted through the bulk of the welded material, e.g. copper, and the tool might lock and then be sheared off.

As discussed in the above referenced commonly assigned, co-pending application 0101663-3, filed on May 11, 2001, in which an improved friction stir welding tool is described and where it also is suggested that the heat generated in a friction stir welding process, especially when joining of thicker pieces of metal or metal alloy is carried out may become a problem even when improvements have been made in the design of the probe itself.

It has commonly been assumed within the art, that when welding thinner workpieces that variation of the tool speed, or different rotation speed for the shoulder and the probe are good methods for controlling the heat input to the weld zone. However it has been indicated that it may also be necessary to regulate the temperature of the material/probe in order to accomplish a good function in the welding, especially when increasing the dimensions of the probe and the workpieces to be joined.

Our work has indicated that lowering the rotational speed of the probe below 400 rev/min increases the torque experienced by the probe. This means that the larger the torque the greater the dimensions of the probe has to be in order to avoid fracture of the probe.

However increasing the rotation speed above 400 rev/min rapidly increases the temperature of the top surface of the work pieces causing that to become extremely soft before the underlying welded material, e.g. copper becomes sufficiently soften to for welding to take place. This situation may cause the shoulder of the tool to penetrate or plunge over an excessive distance into the softened top surface layer.

### SUMMARY OF THE INVENTION

The object of the invention is to keep the temperature of the tool probe (once stable welding conditions have been achieved within a given range in order to enable consistent weld quality by not overheating or overcooling the weld zone.

It is also an object of the present invention to avoid overheating of the tool and/or hot shearing of the same.

It is also an object of the present invention to reduce wear of the tool probe by achieving a working temperature where the wear is at a minimum while still achieving a consistent weld quality.

It is also an object of to provide an improved friction stir welding tool combination which makes possible temperature control of the probe and thereby also of the welded material in thus giving optimal conditions during the welding process and also an improvement in the weld per se.

According to the invention this is achieved in a controlled cooling system in combination with the friction stir welding tool and in a method for achieving and upholding temperature conditions in the weld which provide a consistent weld quality without flaws resulting either for overheating of overcooling of the weld zone.

### BRIEF DESCRIPTION OF THE DRAWINGS

These and other objects, advantages and features of the present invention will be more readily understood from the following detailed description of a preferred embodiments thereof, when considered in conjunction with the drawings, and wherein:

FIG. 1A is a schematic drawing of a prior art friction stir welding tool;

FIG. 1B is a schematic end view showing a prior art friction stir welding tool in use;

FIG. 2 shows a friction stir welding probe combination according to the present invention including a temperature control arrangement.

FIG. 3 shows a schematic drawing of a control system in a stir welding tool according to the invention.

FIG. 4 shows an idealised weld record to demonstrate clearly the course of the parameters measured and/or controlled while accomplishing a friction stir weld.

FIG. 5 shows a weld record of a weld according to the invention showing the tool probe core temperature and the chilled coolant temperature in relation to other parameters

FIG. 6 shows a flow sheet describing the process used in the welding according to the invention.

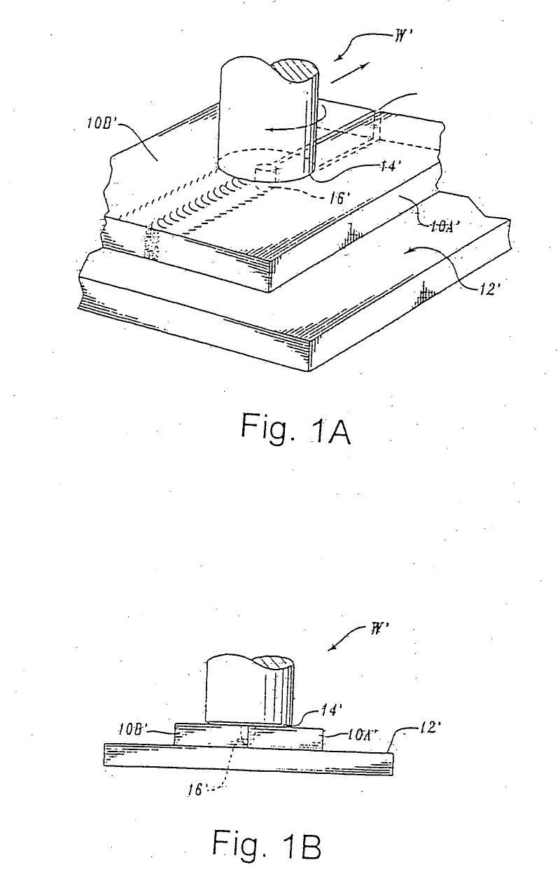

### DETAILED DESCRIPTION OF THE PREFERRED EMBODIMENTS OF THE INVENTION

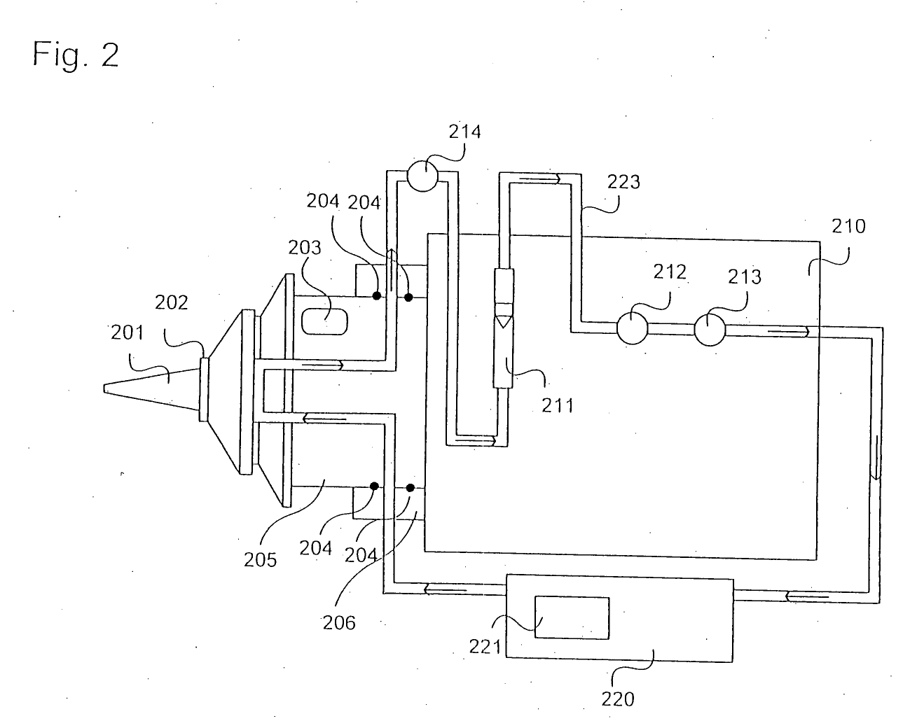

In accordance with the invention excess heat is removed from a stir welding tool in order to achieve an improved weld structure throughout the whole weld. In accordance with the invention an embodiment of a temperature control arrangement for a friction stir welding tool and process is described. In the drawing, shown in FIG. 2, a friction stir welding probe 201 and the shoulder 202 thereof is shown mounted on a tool body 210.

In this drawing is also indicated that the friction stir welding tool has one non-rotating part 206, 210 and a rotating part 205, 202, and 201.

A temperature control arrangement is shown. Within the tool body 210 and in contact with the tool shoulder a tool temperature controlling circuit 223 is shown. The conduit passes through both the rotating and the non-rotating parts of the friction stir welding tool. In order to accomplish this rotating seals 204 are arranged at the interface between the two parts.

A chilling unit 220 is arranged in the conduit 223 for chilling the coolant in the conduit 123 before it passes the probe 201. The coolant may be either a liquid or a gas. In the drawing only one conduit is shown, however, as the man skilled in the art will understand, the conduits could be several and still fulfil the same purpose. In the conduit 223 a fluid meter 211, a pressure gauge 212, and a flow control meter 213 are indicated. A temperature measuring device 214 for measuring the return coolant is arranged in the conduit 223.

An instrumentation block 203 is shown, which contains a data logger in which the temperature of the tool probe is recorded. The block could e.g. comprise an amplifier for a thermocouple e.m.f., the thermocouple used for measuring the tool temperature. The e.m.f. may be taken from the rotating shaft by means of a slip ring and displayed in real time.

The instrumentation above that is not of particular importance to the invention.

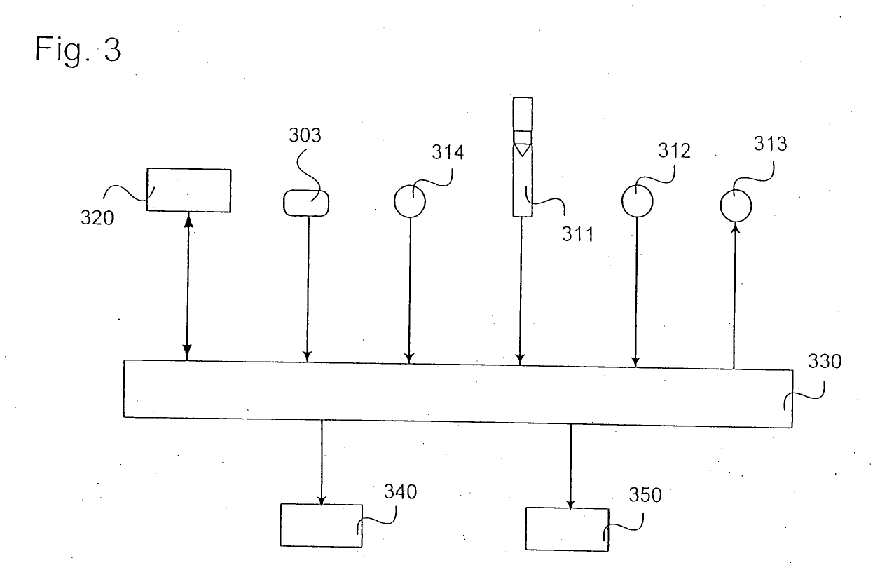

In FIG. 3 is shown a control system according to the invention for controlling the friction stir welding parameters during the weld, especially the temperature of the probe. A control unit 330 in which a friction stir welding control program may be run in order to control the welding sequence. The control unit 330 receives variables from the instrumentation block 303 the FSW probe temperature, the return coolant temperature form the return coolant temperature registering device 314, flow measurements from the flow meter 311, pressure measurements from the pressure gauge 312, and the temperature of the coolant exiting the chilling unit and entering the temperature controlling circuit (not shown). The received and measured variables are used for controlling the flow in the temperature controlling circuit by adjusting the flow in the circuit by means of a pump 313, controlling the temperature of the coolant exiting the chilling unit 320, adjusting the traverse rate 340 of the probe 350 versus the workpieces being welded. Even though it has been mentioned before that a rotational speed has been found, which works well in connection with welding thicker pieces of copper and that decreasing or increasing the rotational speed is not a first option it may under other circumstances when welding other material be an option to control the rotational speed of the probe 350.

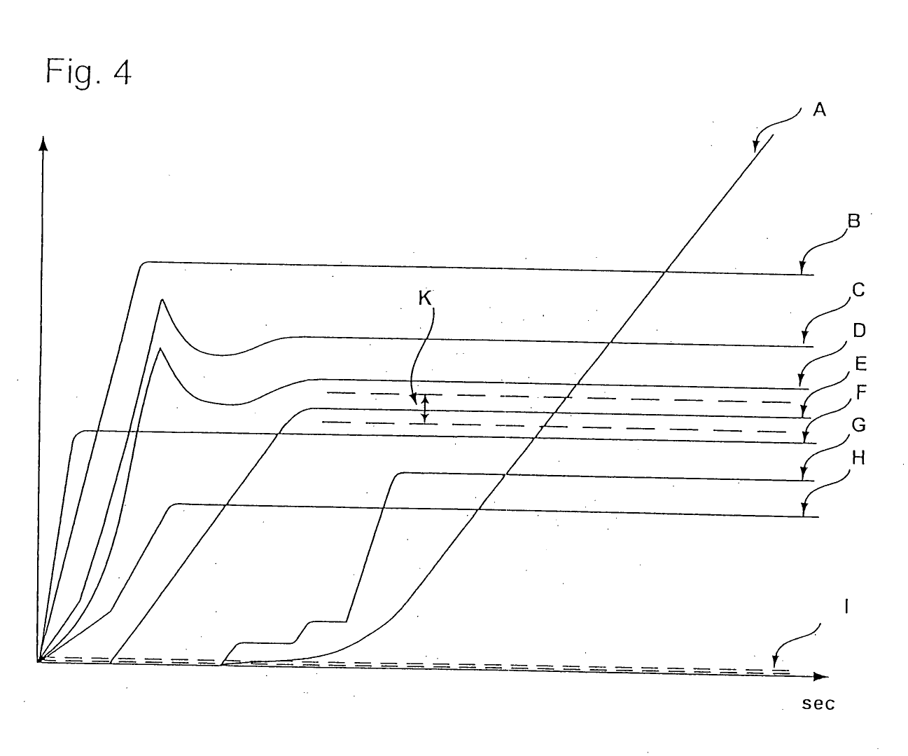

Referring now to FIG. 4, in which is illustrated various variables during a typical weld sequence according to the invention. It is shown that the rotational speed of the friction stir welding tool is kept essentially constant, in this instance exemplified by the curve (F) The temperature of the chilled coolant is kept essentially between 10-40° C. curve (I). In the claims referred to as a first predetermined temperature.

It is seen from the diagram that the temperature of the probe, curve (E), rises comparatively slowly at first, reaches a maximum as the probe traverse rate increases, curve (C), approximately 2 to 8 minutes from the introduction of the probe into the welding area. The distance traversed by the probe is shown as curve (A). The tool probe core temperature, curve (E) is shown to rise up to approximately the desired predetermined temperature of between 780 to 900° C.

According to the invention the temperature or temperature range of the tool probe, in the claims is referred to as the second predetermined temperature.

However, according to another embodiment of the invention the temperature of the return coolant can be used as a measurement of the probe temperature and that, that temperature or temperature range, in the claims is referred to as the second predetermined temperature.

The predetermined temperature may be controlled according to the invention by either chilling the probe indirectly and/or by adjusting the travelling speed, i.e. the relative movement between the probe and the workpieces.

Further the diagram shows the torque, curve (C) as it rises up to a relatively steady level as the predetermined temperature is achieved, curve (E). Also the displacement, curve (B) follows the same course. The displacement is a measure of the forward or backward movement of the probe relative to the work pieces being joined, which gives a temperature rise, just as well as the rotating movement of the probe.

The welding procedure starts by introducing the rotating tool probe at the interface between the workpieces to be joined by friction stir welding, a shoulder contact is established, and a relative movement between tool probe and the workpieces in the direction of the weld to be is begun. The traverse rate is ramped up as may be seen from curve.

Thus according to the invention the welding conditions are controlled such that the tool probe temperature remains fairly constant. This is achieved according to the invention using the cooling system and by making minor adjustments in the travelling speed of the friction stir welding probe in relation to the workpieces being welded. The man skilled in the art will understand that a rotating stationary probe and moving workpieces will be equivalent to stationary workpieces and a travelling and rotating probe. This method of control has shown to have great advantages for production welding, because the upper and the lower limit on the tool probe temperature can be used to control the speed of movement of the material joined by welding via a feedback control loop.

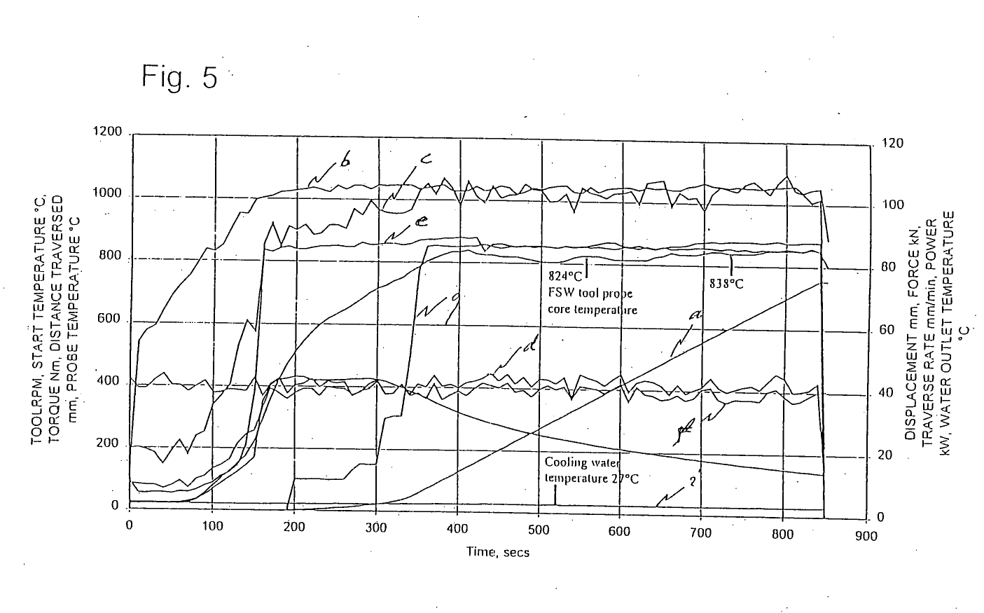

In FIG. 5 is shown an actual weld record of a weld. The curves are denoted as in FIG. 4 only using lower-case letters as a contrast to FIG. 4 where the corresponding upper-case letters are used.

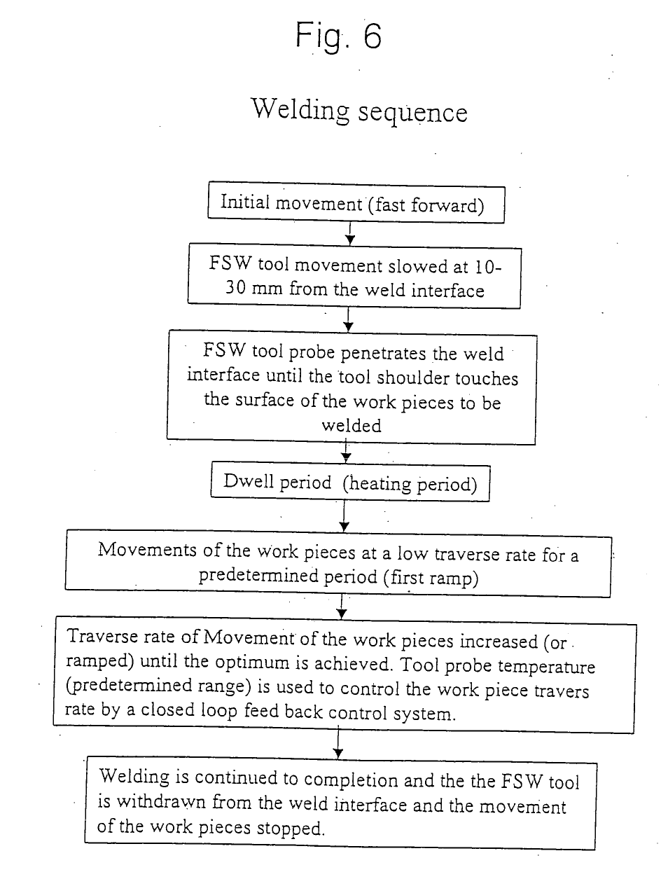

In FIG. 6 a flow diagram is shown describing such. Initially the probe is rotating and the first movement, the Initial movement, is fast forward. The friction stir welding tool movement is slowed at 10-30 mm from the weld interface. Thereafter the tool probe penetrates the weld interface until the tool shoulder touches the surface of the work pieces to be welded. Here a dwell period (heating period) starts and at the end of the movements of the work pieces are instituted at a low traverse rate for a predetermined period (first ramp). The traverse rate of movement of the work pieces is thereafter increased (or ramped) until the optimum is achieved. The tool probe temperature (predetermined range) is used to control the work piece traverse rate by a closed loop feed back control system. Welding is thereafter continued to completion and the friction stir welding tool is withdrawn from the weld interface and the movement of the work pieces stopped.

Although only two exemplary embodiment of the invention has been discussed above, those skilled in the art will readily appreciate that many modifications are possible without departing from the scope of the invention.

1. A method of friction stir welding in which use is made of a rotating friction stir welding tool, said tool having a probe, the method comprising:
(a) temperature control of the tool during welding of a workpiece of hard to weld materials by passing a temperature controlling coolant through one or more channels in the tool in order to control the temperature of the probe, thereby removing excessive heat from the tool and from the area of the workpiece being welded
(b) said coolant having a predetermined first temperature upon entering the tool,
(c) measuring a second predetermined temperature indicative of the tool probe temperature,
(d) controlling the welding process such that the tool probe is kept essentially at a predetermined tool probe temperature.

2. A method according to claim 1 in which the second predetermined temperature is the temperature of the probe.

3. A method according to claim 1 in which the second predetermined temperature is the temperature of the coolant exiting the tool.

4. A method according to claim 1, wherein the temperature controlling coolant is cooled after passage through the tool and recirculated through the tool.

5. A method according to claim 1, wherein the flow of the temperature controlling coolant is controlled in dependence the second predetermined temperature.

6. A method according to claim 1, wherein the welding speed, i.e. the relative speed of the workpiece as it passes the welding tool is controlled in dependence of the second predetermined temperature.

7. A method according to claim 1, wherein the welding speed, i.e. the relative speed of the workpiece versus the welding tool is controlled in dependence of the variation in the tool probe temperature.

8. A method according to claim 1, wherein the flow of the coolant is on from the start of a weld and wherein measurements of temperature in the tool and in the workpiece are used for establishing when an equilibrium condition has been attained, at which the traverse rate, the temperature of the temperature controlling coolant, the force, the probe temperature and the rotating speed of the tool are kept constant.

9. A method according to claim 1, wherein the rotating speed of the tool is kept constant throughout the weld.

10. A method according to claim 1, wherein the first predetermined temperature of the temperature controlling coolant is allowed to vary up until equilibrium is attained.

11. A combination for friction stir welding comprising:
(a) a friction welding tool comprising a probe (201), a shoulder (202), and a tool body (210), said probe (201) and shoulder (202) adapted to generating frictional heat when rotating in contact with workpieces to be welded together, said tool comprising conduits (223) in the tool adapted for coolant contact with a temperature controlling unit (220),
(b) means for registering the temperature of the probe, and
(c) control means (213) for regulating the flow of a temperature controlling coolant through the probe in dependence of a first predetermined temperature and a second predetermined temperature of said coolant.

12. A combination for friction stir welding according to claim 11 wherein said means for registering the temperature of the probe comprises a temperature measuring device mounted in the probe.

13. A combination for friction stir welding according to claim 11 wherein said means for registering the temperature of the probe comprises a temperature measuring device (214) adapted to measure the return coolant temperature on exiting the probe.

14. A combination for friction stir welding according to claim 11 further comprising a control unit (330).

15. A combination for friction stir welding according to claim 11 wherein means for controlling the rotational speed of the friction stir welding probe are adapted to be controlled by said control unit (330).

16. A combination for friction stir welding according to claim 11 wherein means for controlling the welding speed, i.e. the relative speed of the workpiece versus the welding tool are adapted to be controlled by said control unit (330) in feedback to the variation of the temperature of the probe.
